(19) United States
(12) Patent Application Publication
(10) Pub. No.: US 2003/0168359 A1
(43) Pub. Date: Sep. 11, 2003

(54) Container with sterilized portion packages

(76) Inventors: Bernd Meyer, Bremen (DE); Rainer Meyer, Achim (DE)

Correspondence Address: FULBRIGHT & JAWORSKI, LLP, 1301 MCKINNEY, SUITE 5100, HOUSTON, TX, 77010-3095, US

(21) Appl. No.: 10/297,339

(22) PCT Filed: Jun. 19, 2001
(86) PCT No.: PCT/EP01/06899

(30) Foreign Application Priority Data
Jun. 23, 2000 (DE) 100 30 885.6

(51) Int. Cl. B65D 81/24; A23L 3/10

(52) U.S. Cl. 206/205; 206/499; 426/521

(57) ABSTRACT

The application describes a system comprising a container made of sterilisation-proof material and, contained therein, sterilised single-portion packs, suitable for storage individually, for foodstuffs or animal food, and a quantity of liquid needed for the sterilisation process, and also a method of sterilising single-portion packs for foodstuffs or animal food which is performed using said system.

### TECHNICAL FIELD

The invention relates to a novel system for holding and sterilising single-portion packs for foodstuffs or animal food and to a method of sterilising single-portion packs for foodstuffs or animal foods.

### BACKGROUND OF THE INVENTION

Because of the constant increase in the number of one-person households and a growing degree of individualisation in multi-person households, single-portion packs in the food sector are becoming more and more popular. In the case of animal food too, especially for dogs and cats, there is also evidence of a steady increase in the popularity of single-portion packs of moist food, particularly since the traditional tinned packaging for moist food entails certain disadvantages which are difficult to overcome. When a tin has been opened, for example, it easily happens that the remaining food left in the tin begins to dry out and becomes unsightly or, under unfavourable storage conditions, it may go bad. It is also more awkward to remove just the right portion from a tin, and it is more unpleasant for the animal's owner, because additional aids, such as spoons, are needed to empty the tin. Finally, it is difficult to avoid the problem of smells from partially emptied tins.

Single-portion packs for foodstuffs and also for pet food are an attractive alternative which overcomes the problems described above. The production of single-portion packs, however, requires a different technology from the kind known from tins and introduced in the art. This relates not only to the method of filling and sealing the containers (often in the form of bowls made of plastic, aluminium or composite materials), but also to the sterilisation process, because the equipment which might be available for sterilising tins cannot be used, or at least needs considerable rebuilding work. Especially in a plant where both tins and single-portion packs in bowls are produced, this requires separate sterilisation equipment, which requires a greater amount of space and staff and also involves high investment costs.

The problem on which the invention is based is to solve the difficulties described above.

### BRIEF SUMMARY OF THE INVENTION

In accordance with the invention, the problem is solved by means of a system consisting of a container made of material capable of being sterilised and holding sterilised single-portion packs for foodstuffs or animal food suitable for storage individually and containing a quantity of liquid needed for sterilisation.

In one embodiment, the single-portion packs are stacked one on top of the other in the container, the single-portion packs preferably being bowls made of plastic, aluminium or a composite material.

In a preferred embodiment, the bowls have an outer circumference substantially complementary to the inner circumference of the container, the bowls in a particularly preferred embodiment having at least one recess on their outer circumference. In an alternative embodiment the single-portion packs are bags made of plastic or a composite material which may alternatively be arranged side by side.

The liquid present in the container for sterilisation can, for example, be water or preferably an aqueous mineral solution.

In addition, the invention relates to a method of sterilising single-portion packs for foodstuffs or animal food, wherein the filled or sealed single-portion packs are introduced into a container holding a plurality of said single-portion packs, either stacked one on top of the other or arranged side by side; prior to this, simultaneously or subsequently, a quantity of liquid sufficient for sterilising said single-portion packs is introduced into said container; the container is hermetically sealed; and the sealed container is subjected to a sterilisation process.

### DETAILED DESCRIPTION OF THE INVENTION

The system according to the invention makes it possible to sterilise single-portion packs with the same equipment that is used to sterilise conventional tins by using these tins as a kind of miniature steriliser. By placing a plurality of single-portion packs into a container such as a tin which is conventionally used for packaging foodstuffs or animal food directly, and by introducing into said container a quantity of liquid needed for sterilisation, the sterilisation of the single-portion packs can be performed using the equipment designed for the larger containers. It is not necessary to redesign the equipment or to invest in a separate sterilisation unit for single portion packs. As an intermediate step, it is merely necessary to introduce the filled and sealed single-portion packs into the containers. The process of filling and sealing the containers can then be performed using the existing equipment.

In order to be able function as a sterilisation vessel, it goes without saying that the container must be made of sterilisation-proof material, such as metal or a suitable composite material.

At the same time, the system according to the present invention also offers the consumer the advantage that it provides a practical combined package which is easy to handle. After the container has been opened, the single-portion packs, each of which is suitable for storage alone, can be removed and consumed individually.

For the system according to the invention, it is possible, for example, to use conventional 850-ml tins. Single-portion packs or bowls made of plastic, aluminium or composite material are placed in these tins after filling and sealing with a sealing film (depending on the height of the bowls, there can, for example, be 5 to 8 bowls per tin). Prior to this, simultaneously or subsequently (the latter being preferred to the sake of ease of handling), a quantity of liquid sufficient for sterilisation is introduced into the tin, such as water or an aqueous mineral solution (which can later be used as a mineral drink for pets).

The tin is then hermetically sealed with a lid in a conventional plant and subjected to a sterilisation process.

In order to make optimum use of the internal volume of the tin, the outer circumference of the bowls ought to be as complementary as possible to the inner circumference of the tins. It is nevertheless preferred to provide at least one recess in the edge portion of the bowl in order to facilitate removal of the single-portion packs. The nature of the single-portion packs is not, however, restricted to bowls, but any conceivable shape and form can be used. It is, for example, possible to employ bag-type packages (pouches), which can either be stacked one on top of the other in the tin or arranged side by side. If they are to be arranged side by side, sausage-shaped single-portion packs may also be suitable.

The features of the invention disclosed in the above description and in the claims can be essential, both individually and in any combination, for the implementation of the invention in its various embodiments.

What is claimed is:

1. A system comprising a container made of sterilisation-proof material and, contained therein, sterilised single-portion packs suitable for storage individually for foodstuffs or animal food, and a quantity of liquid needed for the sterilisation process.

2. A system as claimed in claim 1, characterised in that the single-portion packs are arranged in the container stacked one on top of the other.

3. A system as claimed in claim 2, characterised in that the single-portion packs are bowls made of plastic, aluminium or a composite material.

4. A system as claimed in claim 3, characterised in that the bowls have an outer circumference substantially complementary to the inner circumference of the container.

5. A system as claimed in claim 4, characterised in that the bowls have at least one recess in their outer circumference.

6. A system as claimed in claim 2, characterised in that the single-portion packs are bags made of plastic or a composite material.

7. A system as claimed in claim 1, characterised in that the single-portion packs are arranged in the container side by side.

8. A system as claimed in claim 7, characterised in that the single-portion packs are bags made of plastic or a composite material.

9. A system as claimed in any of the preceding claims, characterised in that the liquid is water or an aqueous mineral solution.

10. A method of sterilising single-portion packs for foodstuffs or animal food, characterised in that the filled and sealed single-portion packs are introduced into a container holding a plurality of said single-portion packs, either stacked one on top of the other or arranged side by side; prior to this, simultaneously or subsequently, a quantity of liquid sufficient for sterilising said single-portion packs is introduced into said container; the container is hermetically sealed; and the sealed container is subjected to a sterilisation process.
